(19) United States
(12) Patent Application Publication
(10) Pub. No.: US 2017/0211838 A1
(43) Pub. Date: Jul. 27, 2017

(54) IMAGE BASED HVAC

(71) Applicant: Vivint, Inc., Provo, UT (US)

(72) Inventors: Michael D. Child, Lehi, UT (US); Michelle Zundel, Draper, UT (US)

(21) Appl. No.: 15/002,510

(22) Filed: Jan. 21, 2016

(51) Int. Cl. F24F 11/00; G06K 9/00; H04N 7/18; G05B 15/02

(52) U.S. Cl. CPC F24F 11/0034; G05B 15/02; F24F 11/0012; G06K 9/00369; G06K 9/00342; H04N 7/183; G06K 9/00288; G06K 9/00261; F24F 2011/0035; G06K 2009/00322

(57) ABSTRACT

Methods and systems for image based HVAC control are described. In one embodiments, the systems and methods include detecting a presence of a person that satisfies a predetermined age criteria in a first room of a premises, determining a current temperature of the first room, determining a temperature setting associated with the first room, and adjusting one or more aspects of a heating ventilation and air conditioning (HVAC) system based on the presence of the person in the first room of the premises.

### BACKGROUND

The present disclosure, for example, relates to security and/or automation systems, and more particularly to improving heating ventilation and air conditioning (HVAC) systems.

Security and automation systems are widely deployed to provide various types of communication and functional features such as monitoring, communication, notification, and/or others. These systems may be capable of supporting communication with a user through a communication connection or a system management action.

A premises may include an HVAC system. The HVAC system may include a control interface to set a temperature. In some cases, the control interface may enable a user to create a temperature schedule based on the time of day, day of week, etc. The premises may include two or more rooms whose temperature is controlled by the HVAC system based on the settings of the control interface. In some cases, however, the temperature of at least one of the two or more rooms may routinely fail to align with the temperature settings of the control interface.

### SUMMARY

The present systems and methods may improve the operation of heating ventilation and air conditioning (HVAC) systems. In some cases, the temperature of at least one room of a premises may routinely lag behind the temperature settings of the control interface. For example, one room of a premises may routinely get hotter than other rooms in the premises. Accordingly, the temperature of this room may lag behind the temperature of other rooms in the premises when the HVAC system is cooling the premises. Likewise, a room of a premises may routinely be colder than other rooms in the premises. Accordingly, the temperature of this room may lag behind the temperature of other rooms in the premises when the HVAC system is heating the premises. Thus, the present systems and methods may monitor the temperature of two or more rooms of a premises and compare the current room temperatures to a setting of a control interface of an HVAC system. Meanwhile, the systems and methods may also monitor the location of one or more occupants in the premises. When the present systems and methods detect an occupant is in the kitchen, the systems and methods may detect the temperature of the kitchen and compare this temperature to a temperature setting for the premises. In some cases, the temperature setting may be a single general setting for the entire premises. Alternatively, the systems and methods may include a temperature setting specific to a room. Thus, in some cases, the systems and methods may check for the temperature setting for the premises and/or a temperature setting specific to the kitchen. Upon determining the current temperature does not match the setting, the systems and methods may activate the HVAC system to bring the temperature of the kitchen to match the temperature setting. In some cases, the systems and methods may detect the identity of the occupant and adjust the temperature based on the determined identity. In some cases, the temperature settings may include settings specific to an identified occupant. For example, first temperature settings may be configured for a parent (e.g., cool to 72 F and heat to 68 F) and second temperature settings may be configured for an infant (e.g., cool to 74 F and heat to 72 F). The temperature settings of the infant may be given priority over that of the parent. Thus, when the systems and methods detect the infant and the parent in the kitchen, the systems and methods may adjust the HVAC system to satisfy the settings of the infant. Likewise, if the systems and methods detect the infant in the infant's bedroom and the parent in the kitchen, the systems and methods may adjust the HVAC system to prioritize operation on the infant's bedroom to satisfy the temperature settings of the infant over those of the parent.

A method for image based HVAC control is described. In one embodiments, the method may include detecting a presence of a person that satisfies a predetermined age criteria in a first room of a premises, determining a current temperature of the first room, determining a temperature setting associated with the first room, and adjusting one or more aspects of a heating ventilation and air conditioning (HVAC) system based on the presence of the person in the first room of the premises. In some cases, the temperature of the first room may be determined by one or more thermistors, the one or more thermistors being located in a camera located in the first room. In some embodiments, the presence of the person in the first room may be detected based at least in part on an image of the person captured by the camera.

In some embodiments, adjusting the one or more aspects of the HVAC system may include calculating a difference between the current temperature of the first room and the temperature setting associated with the first room and adjusting the HVAC system based on the calculated difference.

In some embodiments, the method may include detecting one or more aspects of the person and adjusting the HVAC system based at least in part on the detecting one or more aspects of the person, wherein the one or more aspects of the person include respiratory rate, heartbeat, body temperature.

In some embodiments, adjusting the one or more aspects of the HVAC system may include prioritizing operation of the HVAC system in favor of the first room of the premises over a second room of the premises. In some embodiments, the method may include detecting the person leaving the first room of the premises and entering the second room of the premises and adjusting one or more aspects of the HVAC system based on the person leaving the first room of the premises. Upon identifying the presence of the person in the second room for at least a preset period of time, the method may include prioritizing operation of the HVAC system in favor of the second room of the premises over the first room of the premises.

In some embodiments, the method may include detecting the person in motion in relation to the person leaving the first room and entering the second room. In some cases, the method may include balancing operation of the HVAC system between the first and second rooms while the person is detected as being in motion, wherein the person is detected as being in motion until the person remains in a room of the premises for a preset period of time.

An apparatus for client side queue sharding is also described. In one embodiment, the apparatus may include a processor, memory in electronic communication with the processor, and instructions stored in the memory, the instructions being executable by the processor to perform the steps of detecting a presence of a person that satisfies a predetermined age criteria in a first room of a premises, determining a current temperature of the first room, determining a temperature setting associated with the first room, and adjusting one or more aspects of a heating ventilation and air conditioning (HVAC) system based on the presence of the person in the first room of the premises.

A non-transitory computer-readable medium is also described. The non-transitory computer readable medium may store computer-executable code, the code being executable by a processor to perform the steps of detecting a presence of a person that satisfies a predetermined age criteria in a first room of a premises, determining a current temperature of the first room, determining a temperature setting associated with the first room, and adjusting one or more aspects of a heating ventilation and air conditioning (HVAC) system based on the presence of the person in the first room of the premises.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 shows a block diagram relating to a security and/or an automation system, in accordance with various aspects of this disclosure;

FIG. 2 shows a block diagram of a device relating to a security and/or an automation system, in accordance with various aspects of this disclosure;

FIG. 3 shows a block diagram of a device relating to a security and/or an automation system, in accordance with various aspects of this disclosure;

FIG. 4 shows a block diagram relating to a security and/or an automation system, in accordance with various aspects of this disclosure;

FIG. 5 shows a block diagram of system relating to a security and/or an automation system, in accordance with various aspects of this disclosure

FIG. 6 is a flow chart illustrating an example of a method relating to a security and/or an automation system, in accordance with various aspects of this disclosure; and

FIG. 7 is a flow chart illustrating an example of a method relating to a security and/or an automation system, in accordance with various aspects of this disclosure.

### DETAILED DESCRIPTION

The following relates generally to improving the operation of heating ventilation and air conditioning (HVAC) systems. The typical HVAC system is composed of a single thermostat located in a central location. This single thermostat controls the heating and cooling of an entire home. Different areas of the home, however, experience varying amounts of heating and cooling due to outdoor weather conditions. The desire to heat or cool the home is determined largely by aspects of the outdoor environment. Aspects such as outdoor temperature, outdoor humidity levels, precipitation, atmospheric pressure, wind, and cloud cover can determine the amount of heating or cooling a building such as a home or office require to maintain a comfortable indoor environment. A typical premises, however, simply sets a target temperature for a wide range of outdoor environmental aspects. For example, while a thermostat may be set to cool a premises to maintain a certain temperature during the summer and parts of spring and fall, the indoor level of comfort may vary based on outdoor conditions. Likewise, the same thermostat may be set to heat a premises to maintain a certain temperature during the winter and parts of spring and fall, while the indoor level of comfort varies due to outdoor conditions. For instance, a south-facing, un-shaded room in the summer may experience a higher room temperature than a shaded south-facing room of the same home. Likewise, a south-facing room is likely to be warmer due to outdoor conditions than a north-facing room. Similarly, an upper-level room is likely to be warmer than a lower-level room. Nonetheless, the heating and cooling of a typical home is controlled by a central thermostat, resulting in some rooms being served adequately and others being served inadequately. Such temperature fluctuations may affect each member of a home differently. For example, the average, healthy child, teenager, or middle-aged adult may not be affected by temperature fluctuations the same way an infant or senor-aged adult may be. For example, if the bedroom of an infant is located in a lower-level, north-facing room, the room of the infant may be colder on average than the rest of the home. The more the temperature of the bedroom of the infant fluctuates compared to the average temperature fluctuation of the home, the more likely the chance the infant of becoming uncomfortable due to the temperature fluctuations. Accordingly, the systems and methods described herein improve the typical HVAC system to address such concerns

In one embodiment, the present systems and methods remedy the identified problems of current HVAC systems by incorporating one or more thermistors in relation to a premises. In some embodiments, thermistors may be positioned in one or more rooms of the premises. For example, one or more thermistors may be placed in the bedroom of an infant, in a family room of the premises, in a kitchen of the premises, etc. In some cases, the thermistors may be placed within a camera located in one of the rooms of the premises. In some embodiments, the camera may be a security camera associated with a security and/or automation system of the premises. For example, a camera may be positioned in the room of the infant. The camera may capture one or more images of the infant. Captured images may be analyzed to identify the presence of the infant in the bedroom. This camera may contain one or more thermistors. The one or more thermistors may detect a current temperature of the room. The current temperature may be compared to a temperature setting associated with the bedroom of the infant. In one embodiment, the temperature setting may be a general setting for the premises. In some cases, the temperature setting may be a setting specific to the bedroom of the infant. For example, the temperature setting may specify a temperature of 72 degrees Fahrenheit (F.). The current temperature measured by the one or more thermistors in the camera may indicate the infant's room is currently 70 F. According to the present systems and methods, a command may be sent to the HVAC system of the premises to heat the premises in order to achieve the 72 F setting in the bedroom of the infant. Thus, priority for implementation of the temperature settings for the premises may be determined based on the detected location of the infant within the premises. For example, if the infant is moved from his/her bedroom to the family room, the systems and methods may detect the infant moving from the bedroom to the family room. In some embodiments, a camera with one or more thermistors may be located in the family room. Accordingly, the systems and methods may determine a current temperature of the family room and adjust the HVAC system to achieve the intended temperature setting associated with the family room. If a general setting for the premises is 72 F and the family room is currently 74 F, then a command may be sent to the HVAC system to cool the family room in order to achieve the 72 F temperature setting. Alternatively, if individual temperature settings are assigned on a per room basis, then the specific temperature setting of the family room may be determined and compared to the current temperature of the family room, and a command may be sent to the HVAC to operate based on the current detected conditions. Thus, if the current temperature of the family room is 74 F and has an assigned temperature setting of 72 F, and the current temperature of the infant's room is 70 F and has an assigned temperature setting of 73 F, then priority may be given to either room based on the location of the infant. If the infant is detected as being in the family room, then a command may be sent to the HVAC to cool the family room to 72 F even if this command results in the bedroom of the infant straying further from its temperature setting of 73 F (i.e., cooling the bedroom further). In some embodiments, commands may be sent to remotely-operated heating registers and/or flues within the ducts to achieve a temperature setting based on the location of the infant. For example, the HVAC system may receive a command to heat the infant's room. Accordingly, a command may be sent to adjust one or more flues and/or open a register in the infant's room to direct the heated air to the infant's room. Meanwhile, one or more flues and/or registers may be adjusted to block the heated air from heating the family room. Thus, priority for the operation of the HVAC system may be determined based on the location of the infant within the premises.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

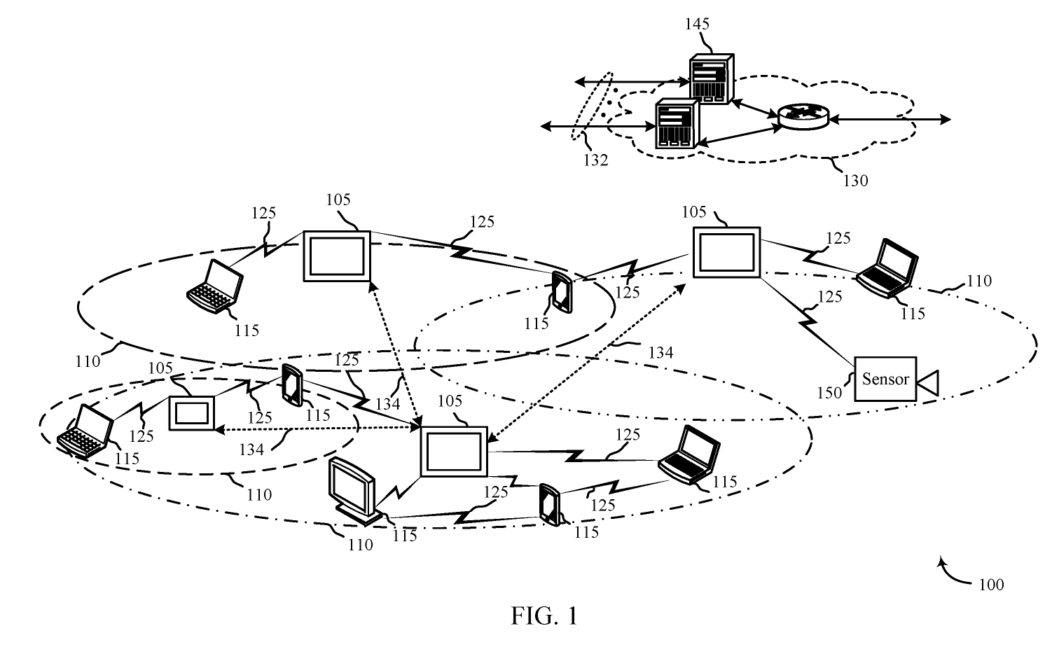

FIG. 1 illustrates an example of a communications system 100 in accordance with various aspects of the disclosure. The communications system 100 may include control panels 105, devices 115, a network 130, and/or sensors 150. The network 130 may provide user authentication, encryption, access authorization, tracking, Internet Protocol (IP) connectivity, and other access, calculation, modification, and/or functions. The control panels 105 may interface with the network 130 through a first set of wired and/or wireless communication links 132 to communicate with one or more remote servers 145. The control panels 105 may perform communication configuration, adjustment, and/or scheduling for communication with the devices 115, or may operate under the control of a controller. In various examples, the control panels 105 may communicate—either directly or indirectly (e.g., through network 130)—with each other over a second set of wired and/or wireless communication links 134. Control panels 105 may communicate with a back end server (such as the remote servers 145)—directly and/or indirectly—using the first set of one or more communication links 132.

The control panels 105 may wirelessly communicate with the devices 115 via one or more antennas. Each of the control panels 105 may provide communication coverage for a respective geographic coverage area 110. In some examples, control panels 105 may be referred to as a control device, a base transceiver station, a radio base station, an access point, a radio transceiver, or some other suitable terminology. The geographic coverage area 110 for a control panel 105 may be divided into sectors making up only a portion of the coverage area. The communications system 100 may include control panels 105 of different types. There may be overlapping geographic coverage areas 110 for one or more different parameters, including different technologies, features, subscriber preferences, hardware, software, technology, and/or methods. For example, each control panel 105 may be related to one or more discrete structures (e.g., a home, a business) and each of the one more discrete structures may be related to one or more discrete areas. In other examples, multiple control panels 105 may be related to the same one or more discrete structures (e.g., multiple control panels relating to a home and/or a business complex).

The devices 115 may be dispersed throughout the communications system 100 and each device 115 may be stationary and/or mobile. A device 115 may include a cellular phone, a personal digital assistant (PDA), a wireless modem, a wireless communication device, a handheld device, a tablet computer, a laptop computer, a cordless phone, a wireless local loop (WLL) station, a display device (e.g., TVs, computer monitors, etc.), a printer, a camera, and/or the like. A device 115 may also include or be referred to by those skilled in the art as a user device, a smartphone, a BLUETOOTH® device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology.

The control panels 105 may wirelessly communicate with the sensors 150 via one or more antennas. The sensors 150 may be dispersed throughout the communications system 100 and each sensor 150 may be stationary and/or mobile. A sensor 150 may include and/or be one or more sensors that sense: proximity, motion, temperatures, humidity, sound level, smoke, structural features (e.g., glass breaking, window position, door position), time, light geo-location data of a user and/or a device, distance, biometrics, weight, speed, height, size, preferences, light, darkness, weather, time, system performance, and/or other inputs that relate to a security and/or an automation system. In some embodiments, sensors 150 may include one or more security cameras located in a premises. In some cases, each camera may include one or more thermistors. For example, each camera may include one or more thermistors enclosed in the camera. Accordingly, the sensors 150 may be configured to capture images and/or video of an area where the camera is located while simultaneously detecting temperature of the area (e.g., room, hallway, etc.). A device 115 and/or a sensor 150 may be able to communicate through one or more wired and/or wireless connections with various components such as control panels, base stations, and/or network equipment (e.g., servers, wireless communication points, etc.) and/or the like.

The communication links 125 shown in communications system 100 may include uplink (UL) transmissions from a device 115 to a control panel 105, and/or downlink (DL) transmissions, from a control panel 105 to a device 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies. Each modulated signal may be sent on a different sub-carrier and may carry control information (e.g., reference signals, control channels, etc.), overhead information, user data, etc. The communication links 125 may transmit bidirectional communications and/or unidirectional communications. Communication links 125 may include one or more connections, including but not limited to, 345 MHz, Wi-Fi, BLUETOOTH®, BLUETOOTH® Low Energy, cellular, Z-WAVE®, 802.11, peer-to-peer, LAN, WLAN, Ethernet, fire wire, fiber optic, and/or other connection types related to security and/or automation systems.

In some embodiments, of communications system 100, control panels 105 and/or devices 115 may include one or more antennas for employing antenna diversity schemes to improve communication quality and reliability between control panels 105 and devices 115. Additionally or alternatively, control panels 105 and/or devices 115 may employ multiple-input, multiple-output (MIMO) techniques that may take advantage of multi-path, mesh-type environments to transmit multiple spatial layers carrying the same or different coded data.

While the devices 115 may communicate with each other through the control panel 105 using communication links 125, each device 115 may also communicate directly with one or more other devices via one or more direct communication links 134. Two or more devices 115 may communicate via a direct communication link 134 when both devices 115 are in the geographic coverage area 110 or when one or neither devices 115 is within the geographic coverage area 110. Examples of direct communication links 134 may include Wi-Fi Direct, BLUETOOTH®, wired, and/or, and other P2P group connections. The devices 115 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within communications system 100.

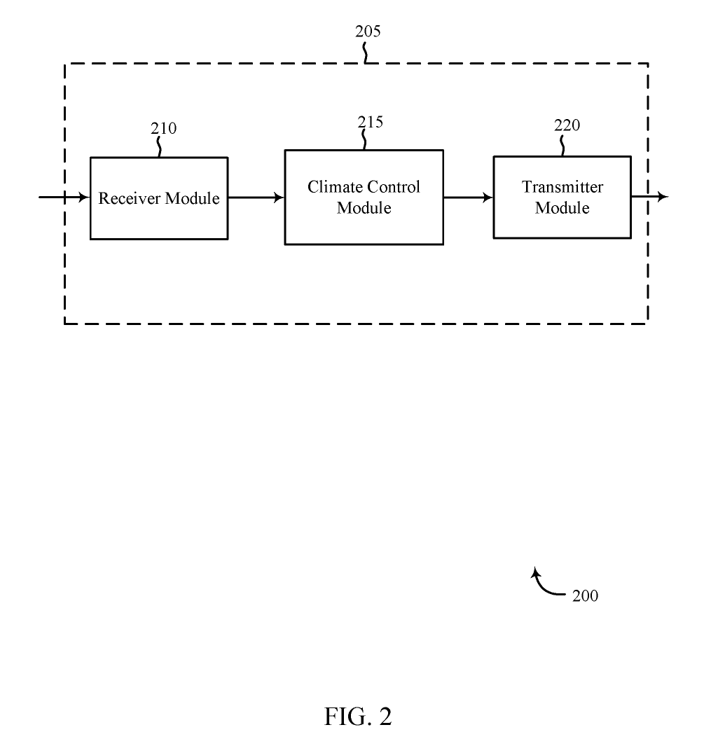

FIG. 2 shows a block diagram 200 of a control panel 205 for use in electronic communication, in accordance with various aspects of this disclosure. The control panel 205 may be an example of one or more aspects of a control panel 105 described with reference to FIG. 1. The control panel 205 may include a receiver module 210, climate control module 215, and/or a transmitter module 220. The control panel 205 may also be or include a processor. Each of these modules may be in communication with each other—directly and/or indirectly.

The components of the control panel 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive images captured by a security camera at a premises, data generated via a security/automation sensor such as a thermistor, motion sensor, etc. In some cases, the receiver module 210 may receive configuration information associated with one or more occupants of the premises, and the like. Information may be passed on to the climate control module 215, and to other components of the control panel 205.

In some embodiments, the climate control module 215 may receive at least a portion of the images captured by the security camera at the premises, data generated via the one or more security/automation sensors, configuration information associated with one or more occupants of the premises, etc. The climate control module 215 may analyze the received data to detect an occupant in a known room of the premises, identify the occupant, determine the age of the occupant, identify one or more preferences associated with the occupant in relation to the operation of an HVAC system, determine a current temperature of the room of the premises, and the like. In some embodiments, climate control module 215 may identify the occupant as an infant. In one embodiment, climate control module 215 may adjust one or more aspects of an HVAC system of the premises based on the identification of the occupant and a determined location of the occupant in the premises.

The transmitter module 220 may transmit the one or more signals received from other components of the control panel 205. The transmitter module 220 may transmit data associated with the results of analysis performed by the climate control module 215. For example, in some cases, the transmitter module 220 may transmit a command to the HVAC system to adjust one or more aspects of the HVAC system. In some examples, the transmitter module 220 may be collocated with the receiver module 210 in a transceiver module.

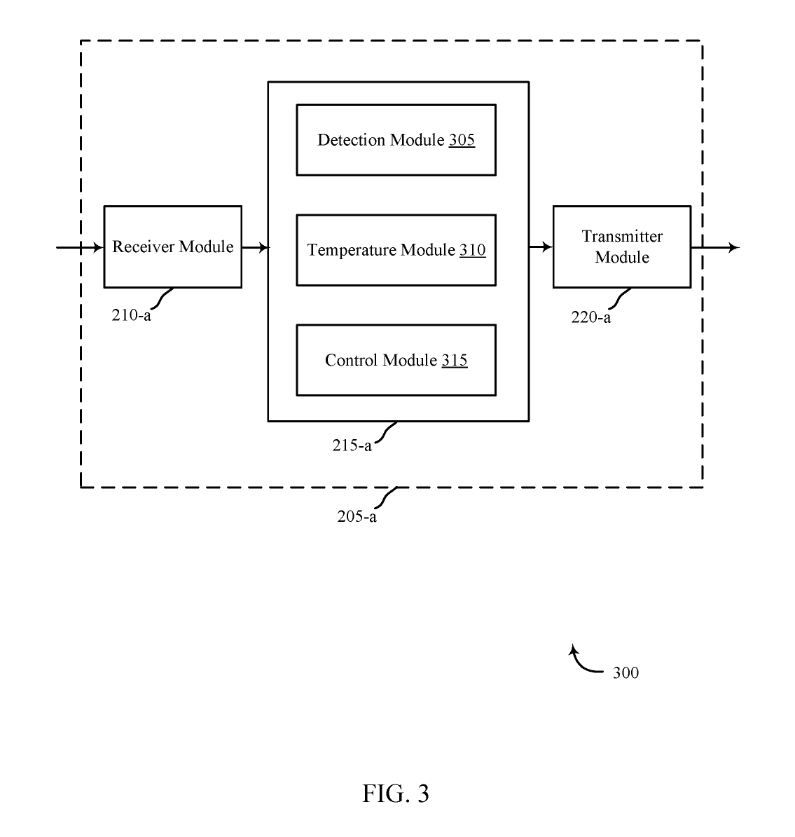

FIG. 3 shows a block diagram 300 of a control panel 205-a for use in wireless communication, in accordance with various examples. The control panel 205-a may be an example of one or more aspects of a control panel 105 described with reference to FIG. 1. It may also be an example of a control panel 205 described with reference to FIG. 2. The control panel 205-a may include a receiver module 210-a, a climate control module 215-a, and/or a transmitter module 220-a, which may be examples of the corresponding modules of control panel 205. The control panel 205-a may also include a processor. Each of these components may be in communication with each other. The climate control module 215-a may include detection module 305, temperature module 310, and control module 315. The receiver module 210-a and the transmitter module 220-a may perform the functions of the receiver module 210 and the transmitter module 220, of FIG. 2, respectively.

The components of the control panel 205-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

In one embodiment, detection module 305 may detect a presence of a person that satisfies a predetermined age criteria in a first room of a premises. In some cases, the presence of the person in the first room may be detected based at least in part on an image of the person captured by a camera.

In some embodiments, the predetermined age criteria may include an age of a newborn (e.g., up to 3 months old), infant (e.g., 3 months to 1 year old), and/or toddler (e.g., 1 year old to 4 years old), etc., at the premises. For example, the presence of an infant in a first room may be detected based at least in part on an image of the infant captured by a camera. In some cases, the presence of the infant may be detected in conjunction with a motion sensor. Additionally, or alternatively, the presence of the infant may be detected in conjunction with a sensor associated with the infant. For example, the infant may wear one or more sensors that track a location of the infant within the premises. In some cases, the sensor may attach to clothing, a pacifier, a blanket, etc. The one or more sensors may include an identifier that is programmatically associated with the infant. In some cases, the premises may include a local positioning system (LPS) that tracks the location of the one or more sensors worn by occupants of the premises, including an infant. In some cases, a facial algorithm may be performed to identify the face of the infant. In some embodiments, the infant may be identified based on an image of an occupant of the premises carrying the infant. In some cases, the face of an occupant may be identified in relation to a face of the infant. In some configurations, an image of an adult face and an image of the infant's face may be captured and compared to identify the infant. For example, the relative compressed features of an infant may be detected in relation to an image of an adult or young adult positioned in relation to the infant in the captured image. In some cases, the infant's body may be identified in relation to the face of the infant in the captured image. The relative small size of the infant body to the infant's head and/or face may assist in identifying the presence of the infant. In one embodiment, an occupant of the premises may be detected carrying the infant. For example, the arm positions of the occupant may indicate the occupant is carrying the infant. The walking pattern or gait of the occupant may indicate the occupant is carrying the infant. The face of the infant relative to the face of the occupant may indicate the occupant is carrying the infant. For example, an image may be captured of an infant resting its head on the shoulder of the occupant, an analysis of which may indicate the presence of the infant. In some cases, analysis of two or more captured images may indicate the face of the infant may be moving simultaneously with the face of the occupant and the two faces are maintaining a certain proximity relative to each other as they move, thus indicating the presence of the infant in relation to the location where the images were captured.

In some embodiments, detection module 305 may detect one or more aspects of the person. In some cases, the one or more aspects of the person may include identity, estimated age, respiratory rate, heartbeat, body temperature, etc. In some cases, the one or more detected aspects of the infant may be identified based at least in part on a captured image of the person. In some configurations, control module 315 may adjust the HVAC system based at least in part on the detecting one or more aspects of the person.

In some embodiments, detection module 305 may detect the person leaving the first room of the premises and entering the second room of the premises. In some cases, control module 315 may adjust one or more aspects of an HVAC system based on the person leaving the first room of the premises. In some embodiments, detection module 305 may detect the person in motion based on the person leaving the first room and entering the second room. In some cases, detection module 305 may detect the person's absence in the first room and/or detect the person's presence in the second room. Accordingly, control module 315 may adjust the HVAC system based on the detection of the person leaving the first room and/or detecting the person's presence in the second room.

In one embodiment, temperature module 310 may determine a current temperature of the first room based on detecting the person in the first room. In some cases, upon detecting the presence of the first person in the first room the temperature module 310 may determine a temperature setting associated with the premises. For example, in some embodiments, temperature module 310 may determine a temperature setting for the premises. Additionally, or alternatively, temperature module 310 may determine a temperature setting for the first room. In some cases, the temperature of the first room may be determined by one or more thermistors. In some embodiments, the one or more thermistors may be associated a camera located in the first room. For example, in some embodiments, the camera may include one or more thermistors. The thermistors in the camera may be used in conjunction with the temperature module 310 to determine the current temperature of the first room.

Using the example of the person being an infant, in some embodiments, the temperature setting of the first room may include a first temperature setting of the first room for when the infant is in the first room and a second temperature setting of the first room for when the infant is not in the first room. Additionally, or alternatively, the HVAC system may include a first temperature setting for the premises in general and a second temperature setting for a room that contains an infant of the premises. For example, the temperature module 310 may set the first temperature setting for the premises in general at 72 degrees Fahrenheit (F.) and set the second temperature setting for the infant at 74 F.

In one embodiment, temperature module 310 may calculate a difference between the current temperature of the first room and the temperature setting associated with the first room and/or premises. Accordingly, control module 315 may adjust the HVAC system based on the calculated difference. For example, the temperature setting for the premises and/or first room may be set at 72 F. When the person walks into the first room, the temperature module 310 may determine the current temperature of the first room is 70 F. Accordingly, the control module 315 may adjust the HVAC system to bring the current temperature of the first room up to 72 F. As stated above, in one example the temperature setting for the premises and/or first room may be set at 72 F while the temperature setting for the first room when the infant is located in the first room may be 74 F. Accordingly, when a parent enters the first room, the temperature module 310 may determine that the current temperature of the first room, 72 F, matches the general setting for the first room, 72 F. However, the detection module 305 may detect that the infant enters the first room after the occupant. Upon detecting the infant, the temperature module 310 may determine that the current temperature of the first room, 72 F, is 2 degrees below the setting for the first room when the infant is located in the first room, which is 74 F. Accordingly, the control module 315 may refrain from making any adjustment to the HVAC system after the occupant is detected entering the first room, but after detecting the infant entering the first room and determining the current temperature of the first room is 2 degrees below the setting for the first room when the infant is located in the first room, the control module 315 may adjust the HVAC system to raise the temperature of the first room to the 74 F setting.

In one embodiment, control module 315 may prioritize operation of the HVAC system in favor of the first room of the premises over a second room of the premises. For example, upon determining an occupant is in the first room and the second room is not occupied, the control module 315 may prioritize the operation of the HVAC system in favor of the first room over the second room. In some embodiments, control module 315 may balance operation of the HVAC system between the first and second rooms while the person is detected as being in motion, wherein the person is detected as being in motion until the person remains in a room of the premises for a preset period of time. In one embodiment, upon identifying the presence of the person in the second room for at least a preset period of time, control module 315 may prioritize operation of the HVAC system in favor of the second room of the premises over the first room of the premises.

In one embodiment, upon detecting the first room occupied by an adult and the second room occupied by an infant, the control module 315 may determine whether one occupant has a priority over the other occupant. In some cases, detection module 305 may detect the infant in the second room via a camera in the second room. In some cases, temperature module 310 may determine the current temperature of the second room based on one or more thermistors located in the camera in the second room. For example, the control module 315 may configure the HVAC system to prioritize the infant over the adult. Thus, upon detecting the infant in the second room and the adult in the first room, the control module 315 may prioritize operation of the HVAC system to favor the second room over the first room and/or any other room of the premises. Accordingly, in some embodiments the control module 315 may operate a heating/cooling unit to heat/cool the premises according to the current temperature of the second room to achieve a temperature setting for the second room when the infant is located in the second room.

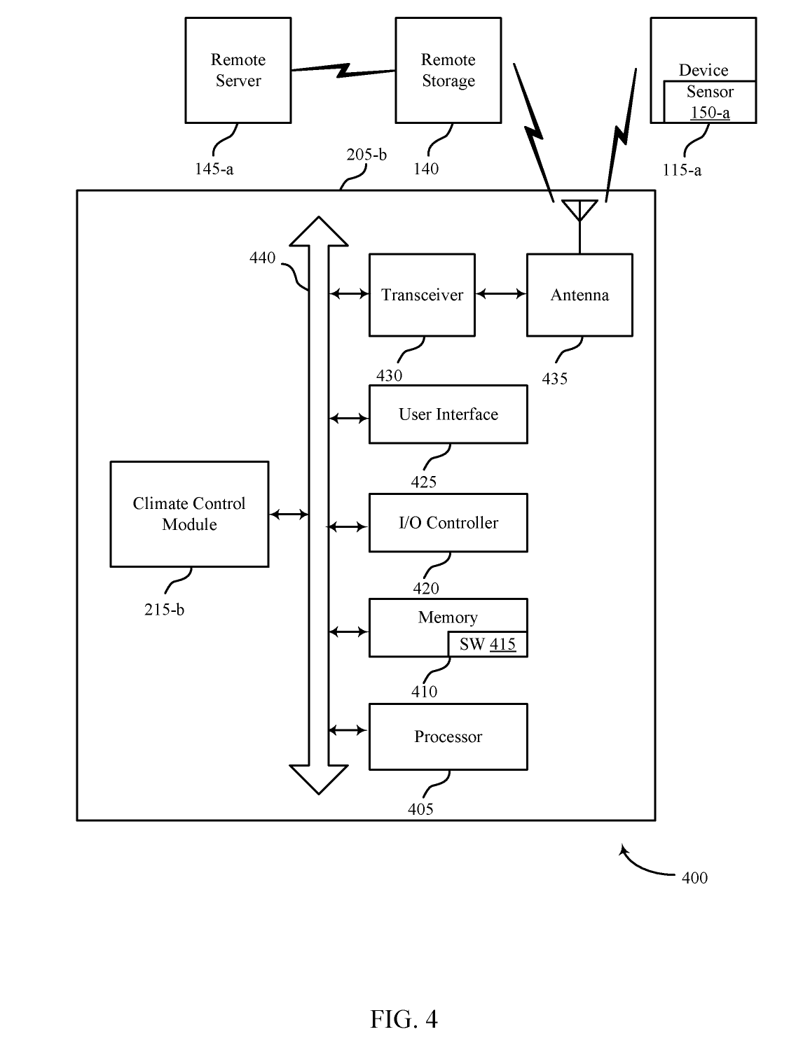

FIG. 4 shows a system 400 for use in image based HVAC control systems, in accordance with various examples. System 400 may include a control panel 205-b, which may be an example of the control panels 105 of FIG. 1. Control panel 205-b may also be an example of one or more aspects of control panels 205 and/or 205-a of FIGS. 2 and 3.

Control panel 205-b may also include components for bi-directional voice and data communications including components for transmitting communications and components for receiving communications. For example, control panel 205-b may communicate bi-directionally with one or more of device 115-a, one or more sensors 150-a, remote storage 140, and/or remote server 145-a, which may be an example of the remote server of FIG. 1. This bi-directional communication may be direct (e.g., control panel 205-b communicating directly with remote storage 140) or indirect (e.g., control panel 205-b communicating indirectly with remote server 145-a through remote storage 140).

Control panel 205-b may also include a processor module 405, and memory 410 (including software/firmware code (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of device 115-a, remote storage 140, and/or remote server 145-a. The transceiver module 430 may include a modem to modulate the packets and provide the modulated packets to the one or more antennas 435 for transmission, and to demodulate packets received from the one or more antenna 435. While a control panel or a control device (e.g., 205-b) may include a single antenna 435, the control panel or the control device may also have multiple antennas 435 capable of concurrently transmitting or receiving multiple wired and/or wireless transmissions. In some embodiments, one element of control panel 205-b (e.g., one or more antennas 435, transceiver module 430, etc.) may provide a direct connection to a remote server 145-a via a direct network link to the Internet via a POP (point of presence). In some embodiments, one element of control panel 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 435 and/or transceiver module 430 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information not specific or exclusive to itself

In some embodiments, one or more sensors 150-a (e.g., motion, proximity, smoke, light, glass break, door, window, carbon monoxide, and/or another sensor) may connect to some element of system 400 via a network using one or more wired and/or wireless connections.

In some embodiments, the user interface module 425 may include an audio device, such as an external speaker system, an external display device such as a display screen, and/or an input device (e.g., remote control device interfaced with the user interface module 425 directly and/or through I/O controller module 420).

One or more buses 440 may allow data communication between one or more elements of control panel 205-b (e.g., processor module 405, memory 410, I/O controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., capturing one or more images of an area viewed by a camera in a room of a premises, analyze the one or more images to identify one or more occupants captured in the images, determine the age of at least one of the occupants, determine a current temperature of the room via one or more thermistors in the camera, determine a temperature settings associated with the premises, room, and/or identified occupant, and adjust an operation of an HVAC system based a on the current temperature and temperature settings and/or the identity of the occupant, etc.). Alternatively, the software/firmware code 415 may not be directly executable by the processor module 405 but may cause a computer (e.g., when compiled and executed) to perform functions described herein. Alternatively, the computer-readable, computer-executable software/firmware code 415 may not be directly executable by the processor module 405 but may be configured to cause a computer (e.g., when compiled and executed) to perform functions described herein. The processor module 405 may include an intelligent hardware device, e.g., a central processing unit (CPU), a microcontroller, an application-specific integrated circuit (ASIC), etc.

In some embodiments, the memory 410 can contain, among other things, the Basic Input-Output system (BIOS) which may control basic hardware and/or software operation such as the interaction with peripheral components or devices. For example, software and/or firmware associated with climate control module 215-b to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to one or may be included as one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be iOS®, ANDROID®, MS-DOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the control panel or control device (e.g., 205-b) may include a single antenna 435, the control panel or control device (e.g., 205-b) may have multiple antennas 435 capable of concurrently transmitting and/or receiving multiple wireless transmissions.

The control panel 205-b may include a climate control module 215-b, which may perform the functions described above for the climate control modules 215 of control panel 205 of FIGS. 2 and 3.

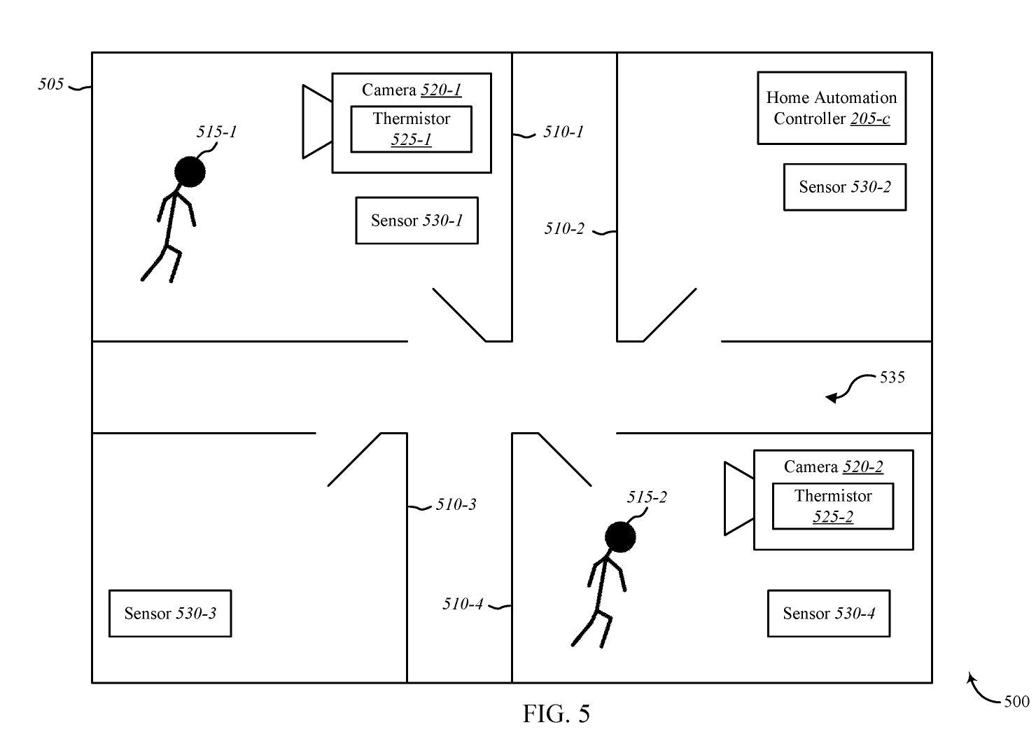

FIG. 5 is a block diagram illustrating one example of an environment 500 for image based HVAC control in conjunction with a home automation controller 205-c, which may be one example of control panel 105 of FIG. 1 and/or control panel 205 of FIGS. 2, 3, and/or 4. In some embodiments, home automation controller 205-c may include one or more software, firmware, and/or hardware components of climate control module 215 of FIGS. 1, 2, 3, and/or 4. As depicted, the premises 505 (e.g., a home, school, or office, etc.) may include one or more rooms. For example, premises 505 may include rooms 510-1, 510-2, 510-3, and 510-4, as well as a central area 535 (e.g., a hallway, an entry way, an reception area, etc.). One or more occupants may be located in one of the rooms. For example, occupant 515-1 may be located in room 510-1 and occupant 515-2 may be located in room 510-4.

As depicted, home automation controller 205-c may be located in one of the rooms. At least one room may include a camera 520 and a sensor 530. For example, room 510-1 may include camera 520-1 and sensor 530-1, room 510-2 may include sensor 530-2, room 510-3 may include sensor 530-3, and room 510-4 may include camera 520-2 and sensor 530-4. Although two rooms are depicted with a camera and two rooms without, it is understood that one room or each room may be configured to include a camera. In some embodiments, cameras 520 and/or sensors 530 may be examples of sensors 150 of FIGS. 1 and/or 4.

In some embodiments, a camera may include a thermistor. For example, camera 520-1 may include thermistor 525-1 and camera 520-2 may include thermistor 525-2. Accordingly, camera 520-1 may detect the presence of occupant 515-1 in room 510-1 and camera 520-2 may detect the presence of occupant 515-2 in room 510-4. Additionally, or alternatively, sensor 530-1 may detect the presence of occupant 515-1 in room 510-1 and sensor 530-4 may detect the presence of occupant 515-2 in room 510-4. Upon detecting the occupants, the cameras 520 and/or sensors 530 may relay information indicating the detected occupants to home automation controller 205-c. Upon receiving the information from cameras 520 and/or sensors 530, in some embodiments, home automation controller 205-c may send a command to thermistor 525-1 to measure a current temperature of room 510-1 and a command to thermistor 525-2 to measure a current temperature of room 510-4. In some embodiments, thermistors 525 may respond to home automation controller 205-c with the current temperatures of these rooms. In some configurations, home automation controller 205-c may compare the current temperatures of these rooms with one or more temperature settings. For example, home automation controller 205-c may compare the current temperatures of these rooms with temperature settings specific to each room. Additionally, or alternatively, home automation controller 205-c may compare the current temperatures of these rooms with a general temperature setting for the premises 505. Home automation controller 205-c may determine that the current temperature of room 510-1 is 70 F, the current temperature of room 510-4 is 74 F, and the temperature setting for the premises 505 is 72 F. Accordingly, home automation controller 205-c may determine the identity of occupants 515-1 and 515-2. In some cases, upon determining the identity of occupants 515-1 and 515-2, home automation controller 205-c may determine a priority between these two occupants. For example, home automation controller 205-c may determine the preferences of occupant 515-2 exceed the preferences of occupant 515-1. Accordingly, home automation controller 205-c, in conjunction with an HVAC system, may heat the premises 505 in order to raise the temperature of room 510-4 from the current temperature of 70 F to the temperature setting of 72 F. In some embodiments, home automation controller 205-c may determine an age associated with occupants 515-1 and 515-2. For example, home automation controller 205-c may determine 515-1 is an infant and 515-2 is an adult. In some embodiments, home automation controller 205-c may prioritize the preferences of an infant occupant over that of an adult occupant. Accordingly, in some embodiments, home automation controller 205-c may cool the premises 505 in order to lower the temperature of room 510-1 from the current temperature of 74 F to the temperature setting of 72 F, thus prioritizing the operation of an HVAC system at the premises 505 based on the location of an infant within the premises.

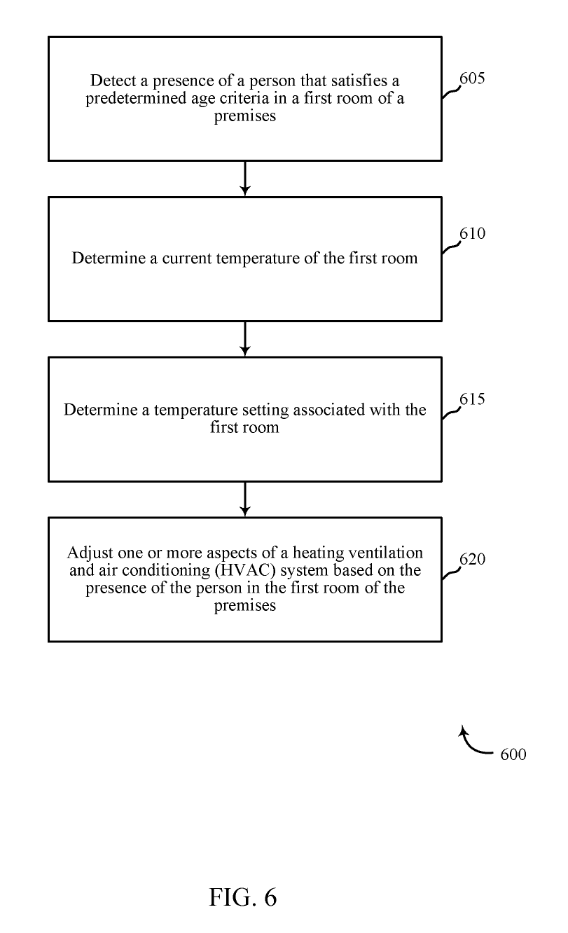

FIG. 6 is a flow chart illustrating an example of a method 600 for adaptive video playback, in accordance with various aspects of the present disclosure. For clarity, the method 600 is described below with reference to aspects of one or more of the control panels 105, devices 115, sensors 150, and/or the one or more remote servers 145 of FIG. 1, and/or aspects of one or more of the adaptive video module 215 described with reference to FIGS. 2, 3, and/or 4. In some examples, a control panel, client device, backend server, and/or sensor may execute one or more sets of codes to perform the functions described below. Additionally or alternatively, the control panel, client device, backend server, and/or sensor may perform one or more of the functions described below using special-purpose hardware.

At block 605, the method 600 may include detecting a presence of a person that satisfies a predetermined age criteria in a first room of a premises. In some embodiments, the presence of the person in the first room is detected based at least in part on an image of the person captured by a camera in the first room. At block 610, the method 600 may include determining a current temperature of the first room. In some cases, the temperature of the first room is determined by one or more thermistors, the one or more thermistors being located in the camera in the first room. At block 615, the method 600 may include determining a temperature setting associated with the first room. At block 620, the method 600 may include adjusting one or more aspects of a heating ventilation and air conditioning (HVAC) system based on the presence of the person in the first room of the premises.

Thus, the method 600 may provide for adaptive video playback in relation to security and automation systems. It should be noted that the method 600 is just one implementation and that the operations of the method 600 may be rearranged or otherwise modified such that other implementations are possible.

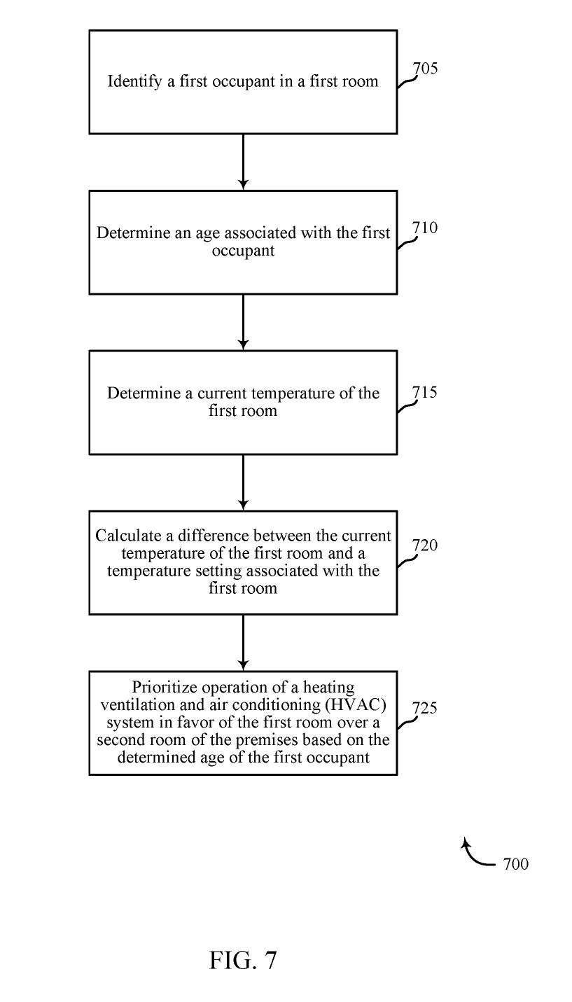

FIG. 7 is a flow chart illustrating an example of a method 700 for adaptive video playback, in accordance with various aspects of the present disclosure. For clarity, the method 700 is described below with reference to aspects of one or more of the control panels 105, devices 115, sensors 150, and/or the one or more remote servers 145 of FIG. 1, and/or aspects of one or more of the adaptive video module 215 described with reference to FIGS. 2, 3, and/or 4. In some examples, a control panel, client device, backend server, and/or sensor may execute one or more sets of codes to perform the functions described below. Additionally or alternatively, the control panel, client device, backend server, and/or sensor may perform one or more of the functions described below using special-purpose hardware.

At block 705, the method 700 may include identifying a first occupant in a first room. At block 710, the method 700 may include determining an age of the first occupant. In some cases, the method 700 may include associating an age with the first occupant based on a determination of an identity of the first occupant. For example, the method 700 may include recognizing the first occupant and then querying a database for information on the identified occupant, which may include the occupants age. In some cases, the queried information may include one or more temperature preferences for the identified occupant. Additionally, or alternatively, the method 700 may include identifying an infant in a room whether or not the identity of the infant is determined or determinable. For example, an analysis of video images may include the method 700 identifying one or more features of an infant to determine an infant is in the room (e.g., identifying body size, identifying a head to body ratio, identifying an infant being carried by an adult, etc.). At block 715, the method 700 may include determining a current temperature of the first room. At block 720, the method 700 may include calculating a difference between the current temperature of the first room and a temperature setting associated with the first room. In some cases, the temperature setting for the room may be based on stored information associated with the identified occupant. For example, the stored information may include an identity of an occupant, an age of the occupant, a temperature setting for a premises and/or a first temperature setting unique to a first room of the premises and a second temperature setting unique to a second room of the premises, etc.). At block 725, the method 700 may include prioritizing operation of a heating ventilation and air conditioning (HVAC) system in favor of the first room over a second room of the premises based on the age of the identified first occupant.

Thus, the method 700 may provide for adaptive video playback in relation to security and automation systems. It should be noted that the method 700 is just one implementation and that the operations of the method 700 may be rearranged or otherwise modified such that other implementations are possible.

In some examples, aspects from two or more of the methods 600 and 700 may be combined and/or separated. It should be noted that the methods 600 and 700 are just example implementations, and that the operations of the methods 600 and 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of”or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for routing messages, comprising:
detecting a presence of a person that satisfies a predetermined age criteria in a first room of a premises;
determining a current temperature of the first room;
determining a temperature setting associated with the first room; and
adjusting one or more aspects of a heating ventilation and air conditioning (HVAC) system based on the presence of the person in the first room of the premises.

2. The method of claim 1, wherein the temperature of the first room is determined by one or more thermistors, the one or more thermistors being located in a camera located in the first room.

3. The method of claim 1, wherein the presence of the person in the first room is detected based at least in part on an image of the person captured by the camera.

4. The method of claim 1, wherein adjusting the one or more aspects of the HVAC system includes:
calculating a difference between the current temperature of the first room and the temperature setting associated with the first room; and
adjusting the HVAC system based on the calculated difference.

5. The method of claim 1, comprising:
detecting one or more aspects of the person; and
adjusting the HVAC system based at least in part on the detecting one or more aspects of the person, wherein the one or more aspects of the person include respiratory rate, heartbeat, body temperature.

6. The method of claim 1, wherein adjusting the one or more aspects of the HVAC system includes:
prioritizing operation of the HVAC system in favor of the first room of the premises over a second room of the premises.

7. The method of claim 6, comprising:
detecting the person leaving the first room of the premises and entering the second room of the premises; and
adjusting one or more aspects of the HVAC system based on the person leaving the first room of the premises.

8. The method of claim 6, comprising:
upon identifying the presence of the person in the second room for at least a preset period of time, prioritizing operation of the HVAC system in favor of the second room of the premises over the first room of the premises.

9. The method of claim 6, comprising:
detecting the person in motion in relation to the person leaving the first room and entering the second room.

10. The method of claim 9, comprising:
balancing operation of the HVAC system between the first and second rooms while the person is detected as being in motion, wherein the person is detected as being in motion until the person remains in a room of the premises for a preset period of time.

11. An apparatus for an automation system, comprising:
a processor;
memory in electronic communication with the processor; and
instructions stored in the memory, the instructions being executable by the processor to perform the steps of:
detecting a presence of a person that satisfies a predetermined age criteria in a first room of a premises;
determining a current temperature of the first room;
determining a temperature setting associated with the first room; and
adjusting one or more aspects of a heating ventilation and air conditioning (HVAC) system based on the presence of the person in the first room of the premises.

12. The apparatus of claim 11, wherein the temperature of the first room is determined by one or more thermistors, the one or more thermistors being located in a camera located in the first room.

13. The apparatus of claim 11, wherein the presence of the person in the first room is detected based at least in part on an image of the person captured by the camera.

14. The apparatus of claim 11, wherein adjusting the one or more aspects of the HVAC system includes:
calculating a difference between the current temperature of the first room and the temperature setting associated with the first room; and
adjusting the HVAC system based on the calculated difference.

15. The apparatus of claim 11, the instructions being executable by the processor to perform the step of:
detecting one or more aspects of the person; and
adjusting the HVAC system based at least in part on the detecting one or more aspects of the person, wherein the one or more aspects of the person include respiratory rate, heartbeat, body temperature.

16. The apparatus of claim 11, wherein adjusting the one or more aspects of the HVAC system includes prioritizing operation of the HVAC system in favor of the first room of the premises over a second room of the premises.

17. The apparatus of claim 16, the instructions being executable by the processor to perform the step of:
detecting the person leaving the first room of the premises and entering the second room of the premises; and
adjusting one or more aspects of the HVAC system based on the person leaving the first room of the premises.

18. The apparatus of claim 16, the instructions being executable by the processor to perform the step of:
upon identifying the presence of the person in the second room for at least a preset period of time, prioritizing operation of the HVAC system in favor of the second room of the premises over the first room of the premises.

19. The apparatus of claim 16, the instructions being executable by the processor to perform the steps of:
detecting the person in motion in relation to the person leaving the first room and entering the second room.

20. A non-transitory computer-readable medium storing computer-executable code for an automation system, the code executable by a processor to perform the steps of:
detecting a presence of a person that satisfies a predetermined age criteria in a first room of a premises;
determining a current temperature of the first room;
determining a temperature setting associated with the first room; and
adjusting one or more aspects of a heating ventilation and air conditioning (HVAC) system based on the presence of the person in the first room of the premises.
